(19) United States
(12) Patent Application Publication
(10) Pub. No.: US 2018/0266146 A1
(43) Pub. Date: Sep. 20, 2018

(54) ELECTRIC LOCK AND CLUTCH MECHANISM THEREOF

(71) Applicant: Taiwan Fu Hsing Industrial Co., Ltd., Kaohsiung City (TW)

(72) Inventors: Lien-Hsi Huang, Kaohsiung City (TW); Wen-Chieh Lee, Kaohsiung City (TW)

(21) Appl. No.: 15/832,747

(22) Filed: Dec. 5, 2017

(30) Foreign Application Priority Data
Mar. 15, 2017 (TW) 106108461

(51) Int. Cl. E05B 47/00; F16D 11/16; G07C 9/00

(52) U.S. Cl. CPC E05B 47/0012; F16D 11/16; G07C 9/00039; E05B 2047/0031; E05B 2047/0017; E05B 2047/0026; E05B 2047/0084; G07C 9/00674

(57) ABSTRACT

An electric lock includes a base, a driving module, a handle and a clutch module. The driving module includes a driving member rotatable relative to the base, and a motor configured to drive the driving member to rotate. The handle is rotatably mounted to the base, and has a plurality of pushing structures. The clutch module includes a clutch base adjacent to the handle, and a clutch unit arranged on the clutch base. Wherein, when the motor drives the driving member to rotate to a first position, the driving member drives the clutch unit to radially move toward the handle, such that the pushing structure is configured to abut against the clutch unit for pushing the clutch base to rotate via the clutch unit when the handle is rotated.

### BACKGROUND OF THE INVENTION

### 1. Field of the Invention

The present invention relates to an electric lock, and more particularly, to an electric lock having a clutch mechanism which is simple and easy to assemble.

### 2. Description of the Prior Art

Generally, an electric lock utilizes a gear transmission mechanism to transmit a torsion torque outputted by a motor, so as to drive a clutch mechanism of the electric lock to engage with or disengage from a latch assembly. When the gear transmission mechanism is forwardly driven by the motor, a pushed structure on the gear transmission mechanism can drive the clutch mechanism to engage with the latch assembly of the electric lock. Accordingly, a torsion torque exerted by a handle can be transmitted to the latch assembly, so that a user can open the door by rotating the handle. When the gear transmission mechanism is reversely driven by the motor, a spring can drive the clutch mechanism to disengage from the latch assembly of the electric lock. Thus, the torsion torque exerted by the handle cannot be transmitted to the latch assembly, so that the latch assembly can keep in a locked status. However, the clutch mechanism and the gear transmission mechanism have complex structures and are not easy to assemble. Therefore, the electric lock of the prior art has higher production cost and lower production efficiency.

### SUMMARY OF THE INVENTION

The present invention provides an electric lock comprising a base, a driving module, a handle and a clutch module. The driving module comprises a driving member rotatable relative to the base, and a motor configured to drive the driving member to rotate. The handle is rotatably mounted to the base, and has a plurality of pushing structures. The clutch module comprises a clutch base adjacent to the handle, and a clutch unit arranged on the clutch base. Wherein, when the motor drives the driving member to rotate to a first position, the driving member drives the clutch unit to radially move toward the handle, such that the pushing structure is configured to abut against the clutch unit for pushing the clutch base to rotate via the clutch unit when the handle is rotated.

The present invention further provides a clutch mechanism of an electric lock comprising a clutch module and a driving module. The clutch module comprises a clutch base and a clutch unit arranged on the clutch base. The clutch unit is radially movable relative to the clutch base. The driving module comprises a driving member and a motor. The driving member is rotatable relative to the clutch module between a first position and a second position. The motor is configured to drive the driving member to rotate. Wherein, when the motor drives the driving member to rotate to the first position, the driving member drives the clutch unit to move radially outward relative to the clutch base to protrude from the clutch base.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an electric lock of the present invention.

FIG. 2 is an exploded view of the electric lock of the present invention.

FIG. 3 is a diagram showing a handle of the electric lock of the present invention.

FIG. 4 is a diagram showing the electric lock of the present invention in an unlocked state.

FIG. 5 is a diagram showing the driving module and the clutch module of FIG. 4 in another angle.

FIG. 6 is a diagram showing the electric lock of the present invention in a locked state.

FIG. 7 is a diagram showing the driving module and the clutch module of FIG. 6 in another angle.

### DETAILED DESCRIPTION

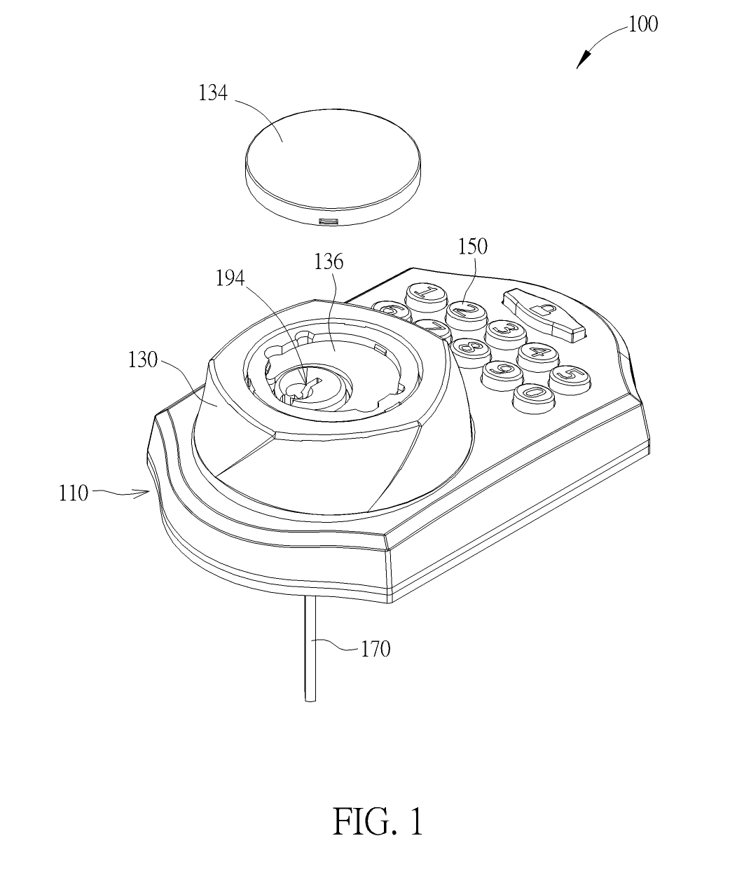

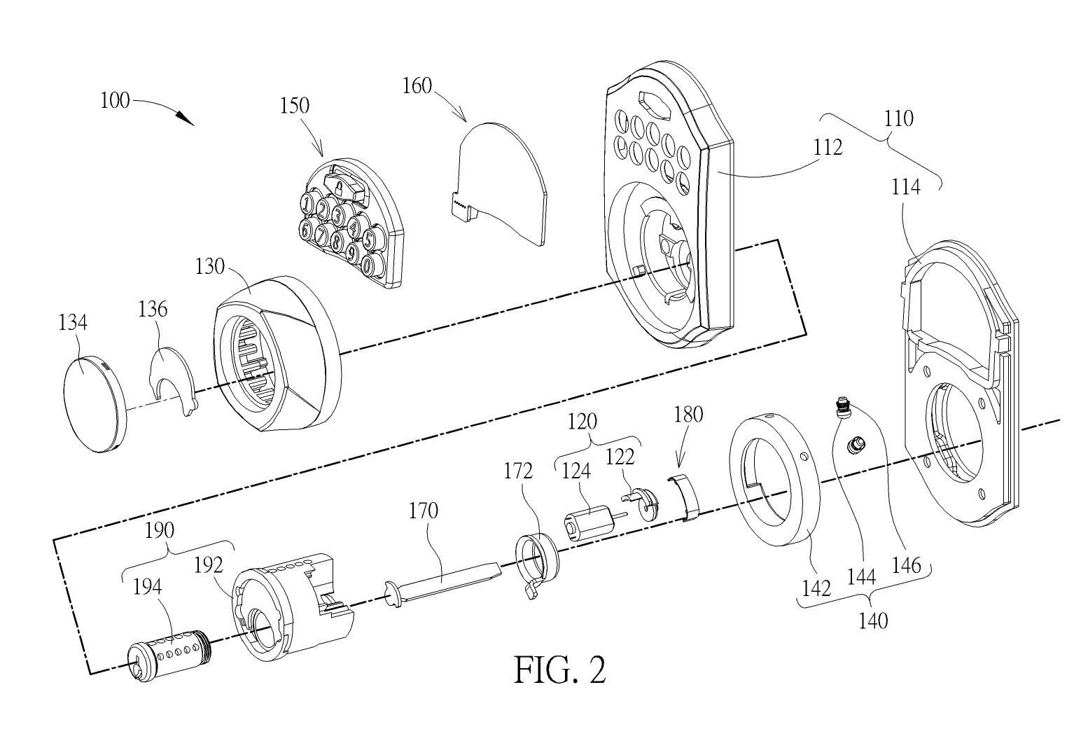

Please refer to FIG. 1 and FIG. 2 together. FIG. 1 is a diagram showing an electric lock of the present invention. FIG. 2 is an exploded view of the electric lock of the present invention. As shown in figures, the electric lock 100 of the present invention comprises a base 110, a driving module 120, a handle 130, a clutch module 140, an input interface 150 and a control unit 160. The electric lock 100 of the present invention can be fixed to a door for controlling movement of a latch on the door. The base 110 comprises a first base body 112 and a second base body 114. The base 110 is configured to accommodate components of the electric lock 100, such as the driving module 120, the clutch module 140, the input interface 150 and the control unit 160. The driving module 120 comprises a driving member 122 and a motor 124. The driving member 122 is rotatable relative to the base 110. The motor 124 is connected to the driving member 122 and configured to drive the driving member 122 to rotate. The handle 130 is installed on the base 110 in a rotatable manner. The clutch module 140 comprises a clutch base 142 and a clutch unit 144. The clutch base 142 is adjacent to the handle 130 and rotatable relative to the base 110. The clutch unit 144 is arranged on the clutch base 142 and radially movably relative to the clutch base 142. The input interface 150 is configured to receive a set of input data. In the present embodiment, the input interface 150 is a numeric keyboard for receiving a password inputted by a user, but the present invention is not limited thereto. In other embodiments of the present invention, the input interface can be a touch panel or other type of input device. The control unit 160 is electrically connected to the input interface 150 and the motor 124 for controlling the motor 124 to rotate when the set of input data matches a set of predetermined data. For example, when the password entered by the user matches a predetermined password, the control unit 160 can control the motor 124 to rotate, in order to further drive related components of the electric lock 100 for controlling the electric lock 100 to be in an unlocked state (or a locked state).

In addition, the electric lock 100 of the present invention further comprises a transmission rod 170 and a transmission member 172. The transmission rod 170 is configured to be connected to a latch (not shown in the figures). When the transmission rod 170 is rotated, the transmission rod 170 is configured to drive the latch to move between an unlocked position and a locked position. The transmission member 172 is sleeved on the transmission rod 170. When the clutch base 142 is rotated, the clutch base 142 is configured to drive the transmission rod 170 to rotate via the transmission member 172, in order to further drive the latch to move. Moreover, the electric lock of the present invention further comprises an elastic module 180 configured to abut against the driving member 122 and the clutch unit 144.

On the other hand, the electric lock of the present invention further comprises a lock assembly 190. The lock assembly 190 comprises a lock housing 192 and a lock core 194. The lock core 194 is arranged on the lock housing 192 and connected to the transmission rod 170. When the lock core 194 is driven by a key, the lock core 194 is configured to drive the transmission rod 170 to rotate, in order to further drive the latch to move. As such, when the electric lock 100 of the present invention loses power, the user can still use the key to perform unlocking or locking operation. Further, the electric lock of the present invention further comprises a cover 134 and a protective piece 136. The cover 134 is configured to cover the lock assembly 190. The protective piece 136 is fixed to the lock housing 192 to prevent the lock core 194 from being damaged or cracked. In the present embodiment, the motor 124 of the driving module 120 is arranged on the lock housing 192, but the present invention is not limited thereto.

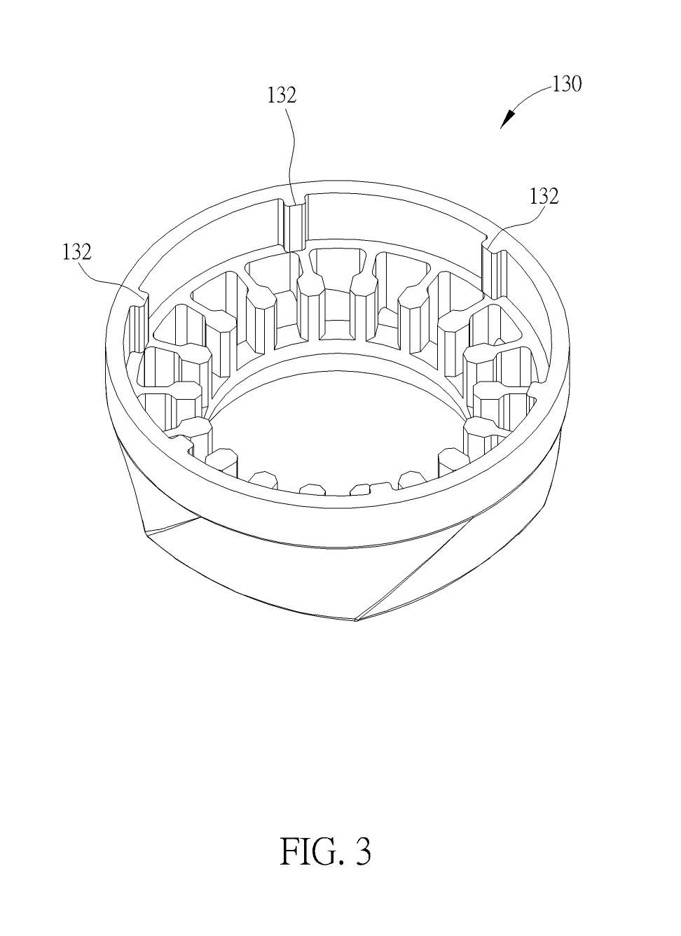

Please refer to FIG. 3. FIG. 3 is a diagram showing the handle of the electric lock of the present invention. As shown in FIG. 3, an inner periphery of the handle 130 of the present invention is formed with a plurality of pushing structures 132. In the present embodiment, the pushing structures 132 are protruded ribs, and a groove is formed between every two pushing structures 132.

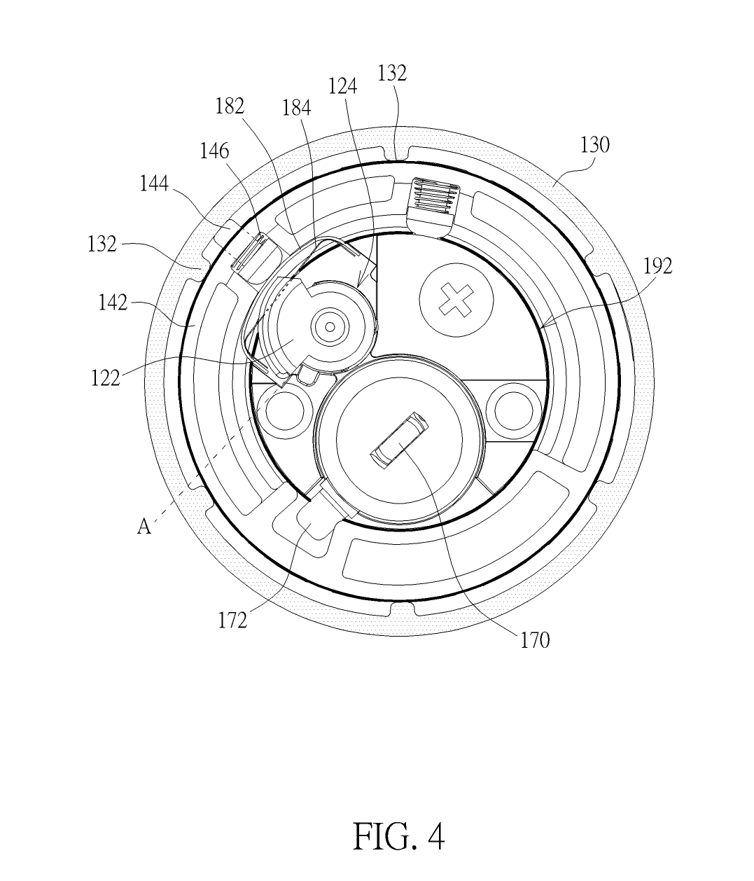

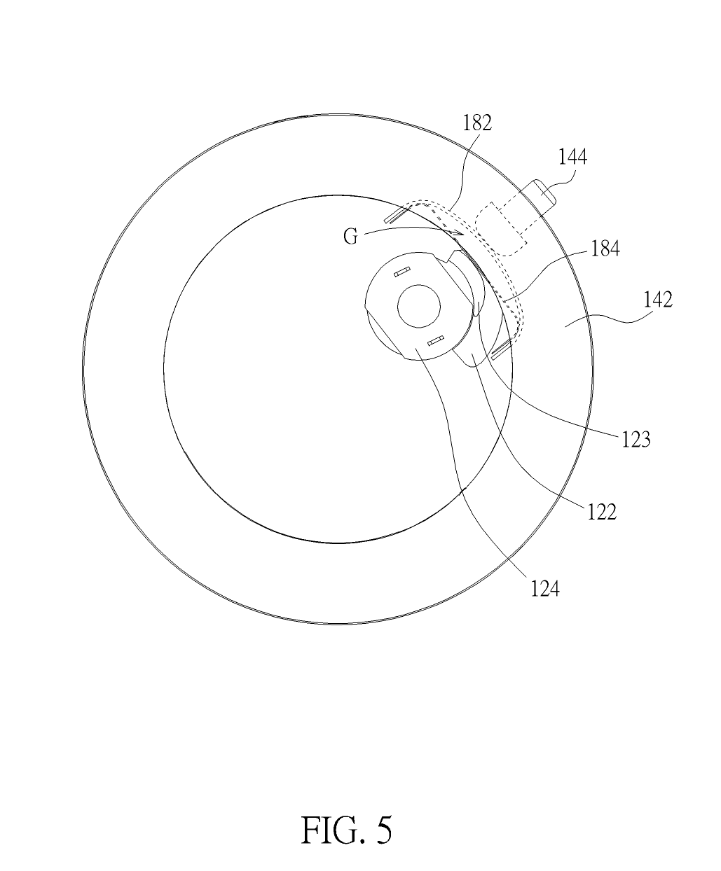

Please refer to FIG. 4 and FIG. 5, and refer to FIG. 2 as well. FIG. 4 is a diagram showing the electric lock of the present invention in an unlocked state. FIG. 5 is a diagram showing the driving module and the clutch module of FIG. 4 in another angle. As shown in figures, the driving member 122 has a protrusion 123 configured to abut against the elastic module 180, and thicknesses of two ends of the protrusion 123 are different. Further, the elastic module 180 comprises a first elastic piece 182 and a second elastic piece 184. The first elastic piece 182 is configured to abut against the clutch unit 144. The second elastic piece 184 is configured to abut against the first elastic piece 182 and the protrusion 123 of the driving member 122. A gap G is formed between the first elastic piece 182 and the second elastic piece 184. When the user controls the electric lock 100 to perform the locking operation via the input interface 150 (for example, a set of input data matches a set of predetermined locking data), the control unit 160 is configured to control the motor 124 to rotate, in order to further drive the driving member 122 to rotate to a first position A. When the driving member 122 is driven to rotate to the first position A, the thicker end of the protrusion 123 drives the clutch unit 144 via the elastic module 180 to radially move toward the handle 130 (or move radially outward relative to the clutch base 142), such that the clutch unit 144 is protruded from the clutch base 142 and located in the groove between two pushing structures 132 of the handle 130. As such, when the user turns the handle 130, the pushing structure 132 is configured to abut against the clutch unit 144 to further drive the clutch base 142 to rotate via the clutch unit 144. Accordingly, the transmission rod 170 is further driven to move the latch from the locked position to the unlocked position.

On the other hand, when the clutch unit 144 is radially moved toward the handle 130 to abut against the pushing structure 132 of the handle 130 without being located in the groove between two pushing structures 132, the gap G between the first elastic piece 182 and the second elastic piece 184 can allow the clutch unit 144 to be retracted backward, in order to prevent mechanical interference between the driving member 122 and the clutch unit 144. When the user further rotates the handle 130, the clutch unit 144 no longer abuts against the pushing structure 132 of the handle 130, such that the clutch unit 144 is pushed to move toward the handle 130 by the first elastic piece 182, so as to allow the clutch unit 144 to be protruded from the clutch base 142 and located in the groove between the two pushing structures 132 of the handle 130. As such, the user can turns the handle 130 to drive the clutch base 142 to rotate via the clutch unit 144, in order to further drive the transmission rod 170 to move the latch from the locked position to the unlocked position.

In the above embodiment, the driving member 122 of the driving module 120 is configured to drive the clutch unit 144 of the clutch module 140 to radially move via the elastic module 180, but the present invention is not limited thereto. In other embodiments of the present invention, the elastic module 180 can be omitted. The driving member 122 and/or the clutch unit 144 can be arranged with other structures (such as flexible structures) for preventing the mechanical interference between the driving member 122 and the clutch unit 144.

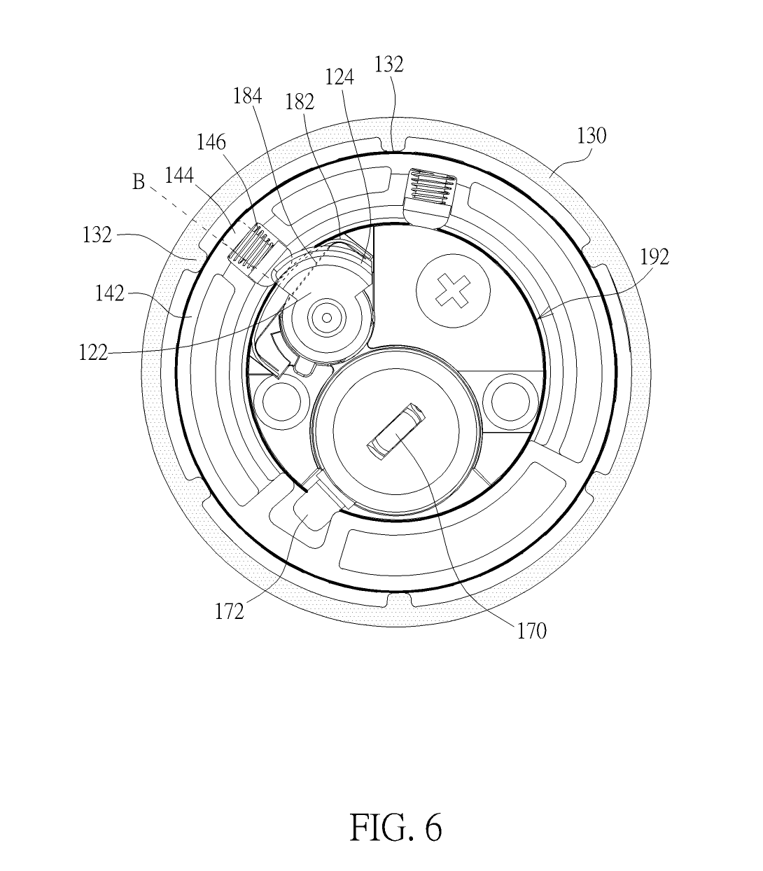

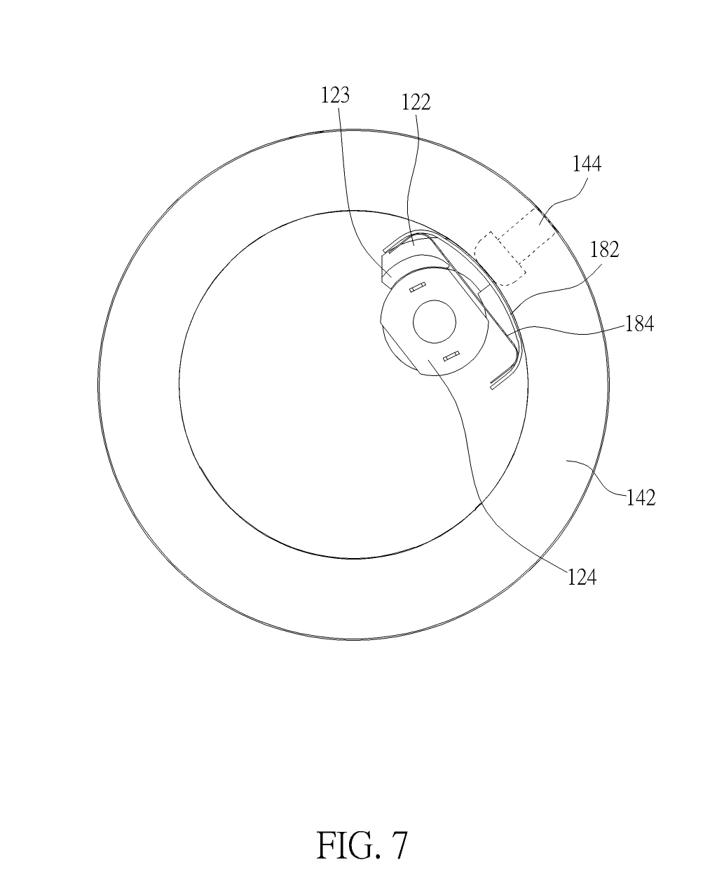

Please refer to FIG. 6 and FIG. 7, and refer to FIG. 2 as well. FIG. 6 is a diagram showing the electric lock of the present invention in a locked state. FIG. 7 is a diagram showing the driving module and the clutch module of FIG. 6 in another angle. As shown in figures, the clutch module 140 further comprises an elastic member 146 configured to push the clutch unit 144 to radially move away from the handle 130 (or move radially inward relative to the clutch base 142). When the user controls the electric lock 100 to perform the locking operation via the input interface 150 (for example, a set of input data matches a set of predetermined locking data), the control unit 160 is configured to control the motor 124 to rotate, in order to further drive the driving member 122 to rotate to a second position B. When the driving member 122 is driven to rotate to the second position B, the thinner end of the protrusion 123 abuts against the elastic module 180, and the elastic member 146 of the clutch module 140 drives the clutch unit 144 to radially move away from the handle 130, such that the clutch unit 144 is no longer located in the groove between the two pushing structures 132 of the handle 130 (or the clutch unit 144 is no longer protruded from the clutch base 142). As such, when the user turns the handle 130, the pushing structure 132 is not able to abut against the clutch unit 144 to drive the clutch base 142 to rotate (that is, the handle 130 is merely rotated without working). In other words, the transmission rod 170 is not driven by the clutch base 142 to move the latch from the locked position to the unlocked position.

In contrast to the prior art, a clutch mechanism (the driving module and the clutch module) of the electric lock of the present invention uses the motor to drive the driving member to rotate, in order to further drive the clutch unit of the clutch module to radially move, so as to control the electric lock to be in the locked state or the unlocked state. The clutch mechanism of the electric lock of the present invention is simple and easy to assemble. Therefore, the present invention can reduce production cost and improve production efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electric lock, comprising:
a base;
a driving module comprising:
a driving member rotatable relative to the base; and
a motor configured to drive the driving member to rotate;
a handle rotatably mounted to the base, and having a plurality of pushing structures; and
a clutch module, comprising:
a clutch base adjacent to the handle; and
a clutch unit arranged on the clutch base;
wherein when the motor drives the driving member to rotate to a first position, the driving member drives the clutch unit to radially move toward the handle, such that the pushing structure is configured to abut against the clutch unit for pushing the clutch base to rotate via the clutch unit when the handle is rotated.

2. The electric lock of claim 1, wherein when the motor drives the driving member to rotate to a second position, the clutch unit is radially moved away from the handle, such that the pushing structure does not abut against the clutch unit when the handle is rotated.

3. The electric lock of claim 1 further comprising an elastic module abutting against the driving member and the clutch unit.

4. The electric lock of claim 3, wherein the elastic module comprises:
a first elastic piece abutting against the clutch unit; and
a second elastic piece abutting against the first elastic piece and the driving member;
wherein a gap is formed between the first elastic piece and the second elastic piece.

5. The electric lock of claim 3, wherein the driving member has a protrusion configured to abut against the elastic module, thicknesses of two ends of the protrusion are different.

6. The electric lock of claim 1 further comprising a transmission rod configured to be connected to a latch, wherein the transmission rod is driven to move the latch by the clutch base when the clutch base is rotated.

7. The electric lock of claim 6 further comprising a transmission member, wherein the clutch base is configured to drive the transmission rod via the transmission member when the clutch base is rotated.

8. The electric lock of claim 6 further comprising a lock assembly, the lock assembly comprising:
a lock housing; and
a lock core arranged on the lock housing, the lock core connected to the transmission rod for being driven by a key to further drive the transmission rod to move the latch.

9. The electric lock of claim 1, further comprising:
an input interface configured to receive a set of input data; and
a control unit electrically connected to the input interface and the motor for controlling the motor to rotate when the set of input data matches a set of predetermined data.

10. The electric lock of claim 1, wherein the clutch module further comprises an elastic member configured to push the clutch unit to radially move away from the handle.

11. A clutch mechanism of an electric lock, comprising:
a clutch module, comprising:
a clutch base;
a clutch unit arranged on the clutch base and radially movable relative to the clutch base; and
a driving module, comprising:
a driving member rotatable relative to the clutch module between a first position and a second position; and
a motor configured to drive the driving member to rotate;
wherein when the motor drives the driving member to rotate to the first position, the driving member drives the clutch unit to move radially outward relative to the clutch base to protrude from the clutch base.

12. The clutch mechanism of claim 11, wherein when the motor drives the driving member to rotate to the second position, the clutch unit is moved radially inward relative to the clutch base without protruding from the clutch base.

13. The clutch mechanism of claim 11 further comprising an elastic module abutting against the driving member and the clutch unit.

14. The clutch mechanism of claim 13, wherein the elastic module comprises:
a first elastic piece abutting against the clutch unit; and
a second elastic piece abutting against the first elastic piece and the driving member;
wherein a gap is formed between the first elastic piece and the second elastic piece.

15. The clutch mechanism of claim 13, wherein the driving member has a protrusion configured to abut against the elastic module, thicknesses of two ends of the protrusion are different.

16. The clutch mechanism of claim 11, wherein the clutch module further comprises an elastic member configured to push the clutch unit to move radially inward relative to the clutch base.
